(19) United States
(12) Patent Application Publication
(10) Pub. No.: US 2010/0228383 A1
(43) Pub. Date: Sep. 9, 2010

(54) Embroidery data generating apparatus and computer-readable medium storing embroidery data generating program

(75) Inventor: Shoichi Taguchi, Toyohashi-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-shi (JP)

(21) Appl. No.: 12/656,309

(22) Filed: Jan. 25, 2010

(30) Foreign Application Priority Data
Mar. 5, 2009 (JP) 2009-052022

(51) Int. Cl. G06T 11/00; D05B 19/00; D05C 5/02

(52) U.S. Cl. 700/138; 112/102.5; 112/475.19

(57) ABSTRACT

The embroidery data generating apparatus includes a data acquisition device that acquires target data and reference data from a plurality of image data, a feature point extraction device that respectively extracts a feature point from the target data and the reference data, a displacement vector identification device that identifies a displacement vector based on the feature point of the target data and the feature point of the reference data, a parameter setting device that sets embroidery parameters based on the displacement vector, and an embroidery data generating device that refers to the embroidery parameters and generates embroidery data.

### CROSS-REFERENCE TO RELATED APPLICATION

This application claims priority to Japanese Patent Application No. 2009-52022, filed Mar. 5, 2009, the disclosure of which is incorporated herein by reference in its entirety.

### BACKGROUND

The present invention relates to an embroidery data generating apparatus and a computer-readable medium that stores an embroidery data generating program that generate embroidery data that are used by a sewing machine to produce a variety of images in embroidered form.

An embroidery data generating apparatus is known that generates embroidery data used in a sewing machine based on a video image or the like. With this type of embroidery data generating apparatus, a user specifies from video images, for example, an image that the user likes. A contour of an area that will be embroidered of the image selected by the user is extracted, and an image of the contour is converted to embroidery data.

### SUMMARY

With the above-described example of the embroidery data generating apparatus, from among video images that are formed of a plurality of contiguous frames, a still image that is a single frame is converted to embroidery data. As a result, in some cases, a sewing machine that performs sewing based on the embroidery data cannot sew an embroidery pattern conveying a dynamic impression that brings to life features of the moving images.

Various exemplary embodiments of the general principles herein provide an embroidery data generating apparatus and a computer readable medium storing an embroidery data generating program that are capable of generating embroidery data that causes a sewing machine to sew an embroidery pattern conveying a dynamic impression that brings to life features of moving images.

The exemplary embodiments provide an embroidery data generating apparatus the includes: a data acquisition device that acquires, from among a plurality of image data, a single image data as a target data, and at least one image data as a reference data, the reference data being different from the target data; a feature point extraction device that extracts, respectively, a first feature point representing a shape of a first target image contained in the target data, and a second feature point representing a shape of a second target image contained in the reference data; a displacement vector identification device that, based on the first feature point and the second feature point extracted by the feature point extraction device, identifies a displacement vector that is obtained when one of the first target image and the second target image is displaced to a position of the other target image; a parameter setting device that, based on the displacement vector identified by the displacement vector identification device, sets embroidery parameters that are referred to when generating embroidery data used to perform embroidery by a sewing machine; and an embroidery data generating device that refers to the embroidery parameters set by the parameter setting device and generates the embroidery data that causes the sewing machine to embroider the first target image.

The exemplary embodiments also provide a computer-readable medium storing an embroidery data generating program. The embroidery data generating program includes instructions that cause a computer to perform the steps of: acquiring, from among a plurality of image data, a single image data as a target data, and at least one image data as a reference data, the reference data being different from the target data; extracting, respectively, a first feature point representing a shape of a first target image contained in the target data, and a second feature point representing a shape of a second target image contained in the reference data; identifying, based on the first feature point and the second feature point, a displacement vector that is obtained when one of the first target image and the second target image is displaced to a position of the other target image; setting, based on the displacement vector, embroidery parameters that are referred to when generating embroidery data used to perform embroidery by a sewing machine; and referring to the embroidery parameters and generating the embroidery data that causes the sewing machine to embroider the first target image.

The exemplary embodiments also provide an embroidery data generating apparatus that includes: a frame acquisition device that respectively acquires from moving image data, of a plurality of contiguous frames included in the moving image data, a freely specified target frame, and a reference frame that includes at least one of a frame that is played back before the target frame and a frame that is played back after the target frame in a playback order of the moving image data; a feature point extraction device that extracts, respectively, a first feature point representing a shape of a first target image contained in the target frame, and a second feature point representing a shape of a second target image contained in the reference frame; a displacement vector identification device that, in accordance with the playback order of the target frame and the reference frame in the moving image data and based on the first feature point and the second feature point extracted by the feature point extraction device, identifies a displacement vector that is obtained when one of the first target image and the second target image is displaced to a position of the other target image; a parameter setting device that, based on the displacement vector identified by the displacement vector identification device, sets embroidery parameters that are referred to when generating embroidery data used to perform embroidery by a sewing machine; and an embroidery data generating device that refers to the embroidery parameters set by the parameter setting device and generates the embroidery data that causes the sewing machine to embroider the first target image.

### BRIEF DESCRIPTION OF THE DRAWINGS

Exemplary embodiments of the present disclosure will be described below in detail with reference to the accompanying drawings in which:

FIG. 1 is an overall configuration diagram that shows a physical configuration of an embroidery data generating apparatus;

FIG. 2 is a block diagram that shows a functional configuration of the embroidery data generating apparatus;

FIG. 3 is an external view of a sewing machine;

FIG. 4 is a figure that shows a data configuration of a reference value table before parameters are set;

FIG. 5 is a figure that shows a first fill stitch sewing mode;

FIG. 6 is a figure that shows a second fill stitch sewing mode;

FIG. 7 is a figure that shows a third fill stitch sewing mode;

FIG. 8 is a figure that shows a fourth fill stitch sewing mode;

FIG. 9 is a figure that shows a fifth fill stitch sewing mode;

FIG. 10 is a figure that shows a sixth fill stitch sewing mode;

FIG. 11 is a figure that shows a seventh fill stitch sewing mode;

FIG. 12 is a figure that shows an eighth fill stitch sewing mode;

FIG. 13 is a figure that shows a data configuration of a parameter setting table;

FIG. 14 is a flow chart that shows a main process of the embroidery data generating apparatus;

FIG. 15 is a figure that shows, as a time series, frames that are displayed when moving image data are played back;

FIG. 16 is a conceptual diagram that shows extraction of feature points of a frame;

FIG. 17 is a conceptual diagram that shows calculation of a barycentric position from a frame;

FIG. 18 is a conceptual diagram that shows acquisition of a displacement vector from a frame;

FIG. 19 is a figure that shows an embroidery pattern before the parameters are set;

FIG. 20 is a figure that shows a data configuration of a parameter setting table;

FIG. 21 is a figure that shows a data configuration of a reference value table after parameters are set; and

FIG. 22 is a figure that shows an embroidery pattern after the parameters are set.

### DETAILED DESCRIPTION

Hereinafter, exemplary embodiments of the present disclosure will be explained with reference to the appended drawings.

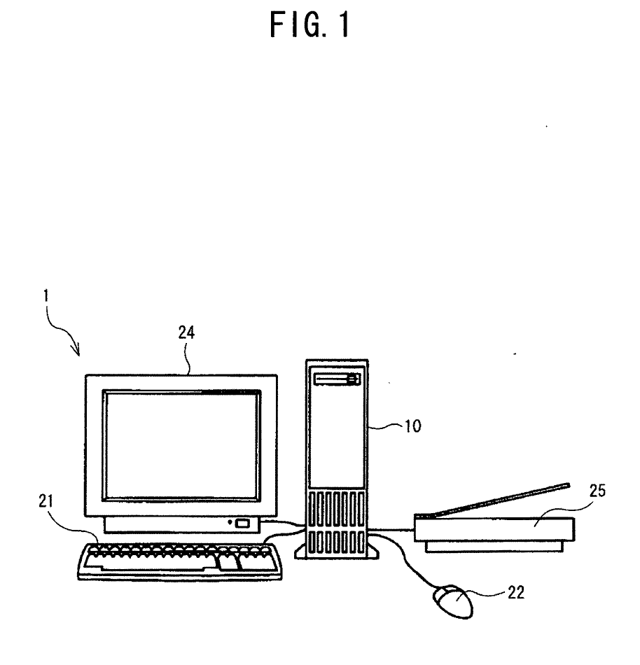

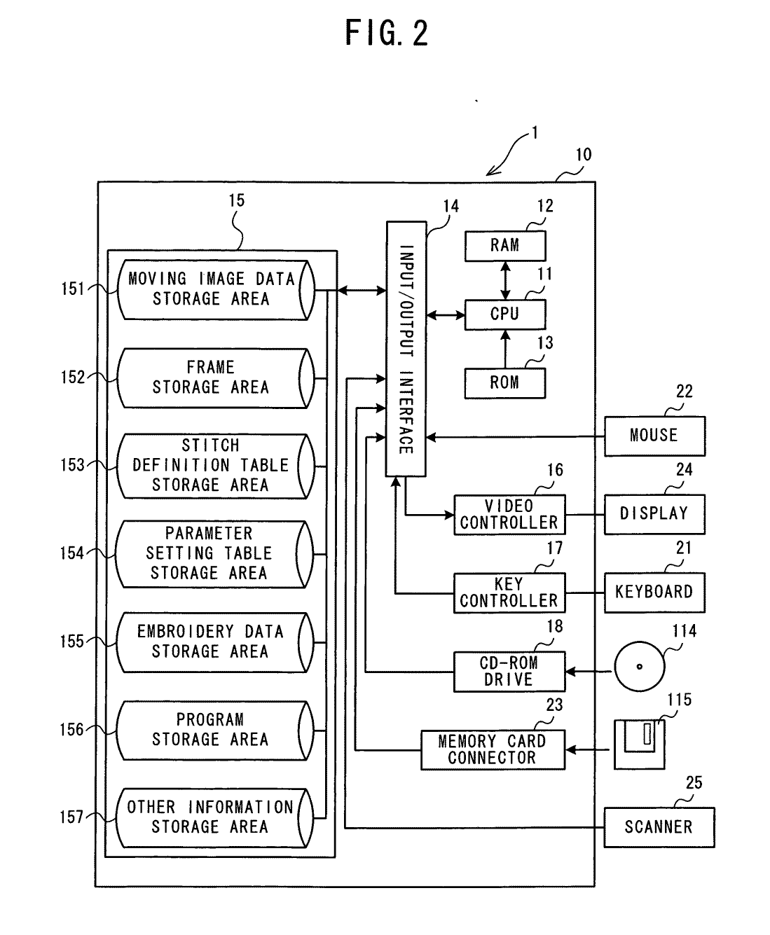

An embroidery data generating apparatus 1 will be explained with reference to FIG. 1 and FIG. 2. The embroidery data generating apparatus 1 generates embroidery data based on image data, the embroidery data being used to cause an sewing machine 3 (to be described later) to sew an image, such as a photograph or an illustration, as an embroidery pattern. As shown in FIG. 1, the physical configuration of the embroidery data generating apparatus 1 is similar to that of a personal computer. The embroidery data generating apparatus 1 is provided with a main device body 10, a keyboard 21, a mouse 22, a display 24, and an image scanner 25 that are connected to the main device body 10.

Next, an electrical configuration of the embroidery data generating apparatus 1 will be explained. As shown in FIG. 2, the main device body 10 is provided with a CPU 11 that is a controller that performs control of the embroidery data generating apparatus 1. A RAM 12, a ROM 13 that stores a BIOS etc., and an input/output (I/O) interface 14 that mediates exchanges of data are connected to the CPU 11.

A hard disk drive (HDD) 15, the mouse 22, a video controller 16, a key controller 17, a CD-ROM drive 18, a memory card connector 23, and the image scanner 25 are connected to the I/O interface 14. The display 24 is connected to the video controller 16. The keyboard 21 is connected to the key controller 17. An embroidery data generating program, which is a program that controls the embroidery data generating apparatus 1, is stored on a CD-ROM 114 that is inserted into the CD-ROM drive 18. When the embroidery data generating program is loaded, the embroidery data generating program is set up from the CD-ROM 114 on the hard disk drive 15 and is stored in a program storage area 156. The memory card connector 23 can read information from and write information into a memory card 115. The scanner 25 reads text or a design etc. that is printed onto a paper medium as image data.

The hard disk drive 15 is provided with at least a moving image data storage area 151, a frame storage area 152, a reference value table storage area 153, a parameter setting table storage area 154, an embroidery data storage area 155, the program storage area 156 and an other information storage area 157.

Moving images that are formed of a plurality of contiguous frames (hereinafter referred to as moving image data) are stored in the moving image data storage area 151. The frames that form the moving image data each form a single image data. In the present embodiment, the moving image data stored in the moving image data storage area 151 are, for example, acquired via a network not shown in the figures. The moving image data stored in the moving image data storage area 151 may also be read from a recording medium (the CD-ROM 114 and the memory card 115, for example).

From among the plurality of contiguous frames that form the moving image data, a target frame and a reference frame are stored in the frame storage area 152. The target frame is a frame that is selected by a user from among the frames that form the moving image data. The reference frame is a frame that either precedes or follows the target frame in the playback order of the moving image data. In the present embodiment, the reference frame stored in the frame storage area 152 is a frame that, when the moving image data are played back, is played back a predetermined period of time (one second, for example) after the target frame.

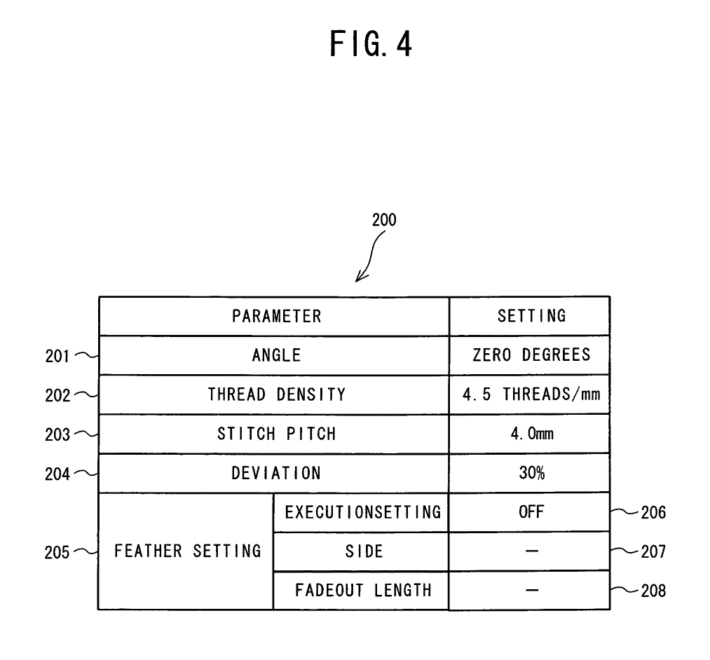

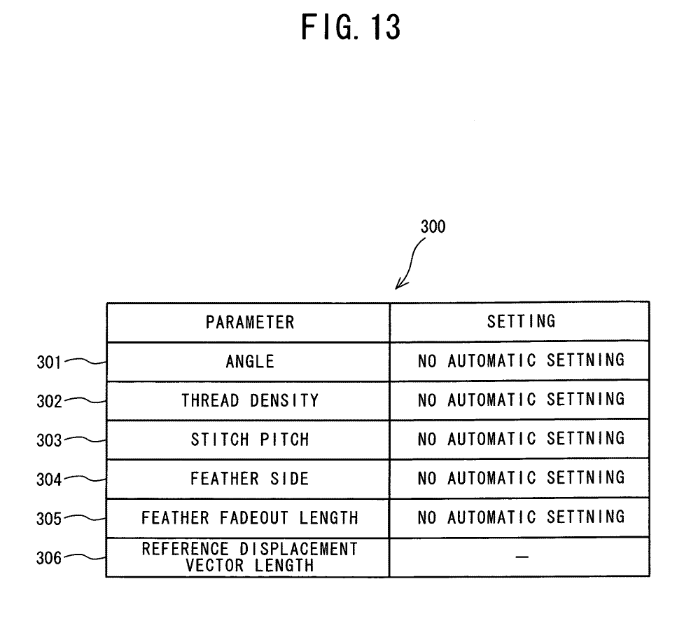

A stitch definition table 200 (refer to FIG. 4), which defines stitches used when the sewing machine 3 sews the embroidery pattern, is stored in the reference value table storage area 153. A parameter setting table 300 (refer to FIG. 13), which defines a method for setting the stitches defined by the stitch definition table 200, is stored in the parameter setting table storage area 154. Embroidery data that are generated by the embroidery data generating apparatus 1 are stored in the embroidery data storage area 155. The embroidery data are used when embroidering is performed by the sewing machine 3. The embroidery data of the present embodiment include information that indicates a color code, an embroidering position, and an embroidering size, as well as stitch data that indicate stitches for producing the embroidery. At least the embroidery data generating program is stored in the program storage area 156. Other information that is used by the embroidery data generating apparatus 1 is stored in the other information storage area 157. In a case where the embroidery data generating apparatus 1 is a dedicated device that is not provided with the hard disk drive 15, the embroidery data generating program is stored in the ROM 13.

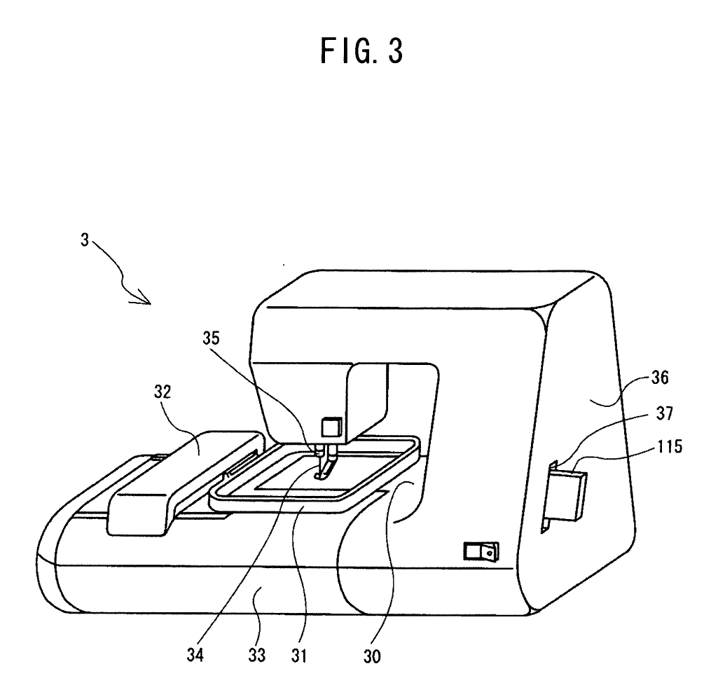

A configuration of the sewing machine 3 will be explained with reference to FIG. 3. As shown in FIG. 3, the sewing machine 3 is provided with a bed portion 30, an embroidery frame 31, a Y direction drive portion 32, a main body case 33, an X direction drive mechanism (not shown in the drawings), a sewing needle 34, a needle bar 35, a shuttle mechanism (not shown in the drawings), and the like. The embroidery frame 31 is disposed on the bed portion 30 and holds a work cloth on which embroidery sewing will be performed. The X direction drive mechanism (not shown in the drawings) is accommodated within the main body case 33. The Y direction drive portion 32 and the X direction drive mechanism (not shown in the drawings) move the embroidery frame 31 to a position that is indicated by an XY coordinate system that is specific to the sewing machine 3. In conjunction with the moving of the embroidery frame 31, the needle bar 35 in which the sewing needle 34 is mounted and the shuttle mechanism (not shown in the drawings) perform sewing on the work cloth that is held by the embroidery frame 31. The Y direction drive portion 32, the X direction drive mechanism, the needle bar 35, and the like are controlled by a control unit (not shown in the drawings) that is configured from a microcomputer or the like that is built into the sewing machine 3.

A memory card slot 37 in which the memory card 115 can be mounted is provided on a side face of a pillar 36 of the sewing machine 3. When the memory card 115, in which the embroidery data are stored, is mounted in the memory card slot 37, the embroidery data are supplied to the sewing machine 3. The control unit (not shown in the drawings) of the sewing machine 3 automatically performs the embroidery operation described above based on the embroidery data that are supplied from the memory card 115.

The stitch definition table 200 and the parameter setting table 300 stored in the hard disk drive 15 will next be explained with reference to FIG. 4 to FIG. 13. A variety of stitching methods can be set on the embroidery data generating apparatus 1 when producing the embroidery pattern, such as fill stitches, satin stitches, running stitches and so on. In the present embodiment, an example is described in which the embroidery data generating apparatus 1 generates the embroidery data that is used by the sewing machine 3 to sew the embroidery pattern using fill stitches. Hereinafter, in the explanation of the stitch definition table 200 and the parameter setting table 300 also, fill stitches and the setting method are defined.

As shown in FIG. 4, the stitch definition table 200 has, as parameters to define the fill stitches, an angle 201, a thread density 202, a stitch pitch 203, a deviation 204 and a feather setting 205. These parameters can be manually set by the user, or can be automatically set based on a displacement vector to be described later. The stitch definition table 200 shown in FIG. 4 shows a default state (namely, a state in which reference value parameters are set) in which the user has not performed manual settings, nor have automatic settings (to be described later) been made. In other words, for as long as the user does not perform manual settings and the automatic settings (to be described later) are not made, the fill stitches are defined by the reference value parameters shown in FIG. 4.

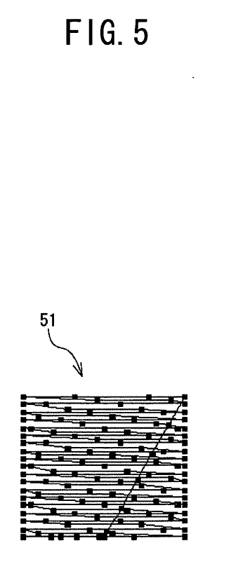

Hereinafter, each parameter will be explained in more detail while referring to a pattern that is sewn as a square shape using the fill stitches defined by the stitch definition table 200 (refer to FIG. 5 to FIG. 12). In the examples shown in FIG. 5 to FIG. 12, needle drop points are shown as black points, and stitches are shown as straight lines linking the needle drop points. In the examples shown in FIG. 5 to FIG. 12, embroidering is performed in line units, each line unit being formed from the left side to the right side of the embroidery pattern. The embroidering is performed continuously from the lower side to the upper side of the embroidery pattern.

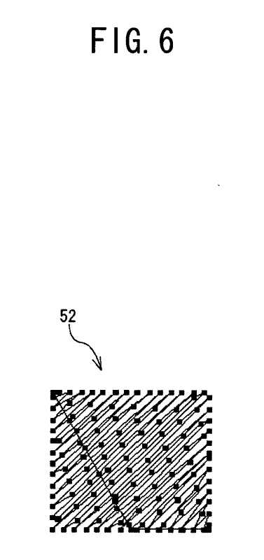

The angle 201 is a parameter that sets a stitching direction of the fill stitches (note that a range of the angle 201 is from “0” to “359”). In the present embodiment, the reference value parameter of the angle 201 is “zero” (refer to FIG. 4). When the angle 201 is set to “zero” on the stitch definition table 200, the stitching direction runs parallel to the left-right direction of the embroidery pattern as shown by a sewing mode 51 (refer to FIG. 5). When the angle 201 is changed, for example, to “45 degrees” on the stitch definition table 200, the stitching direction is inclined at a 45 degree angle with respect to the left-right direction of the embroidery pattern, as shown by a sewing mode 52 (refer to FIG. 6).

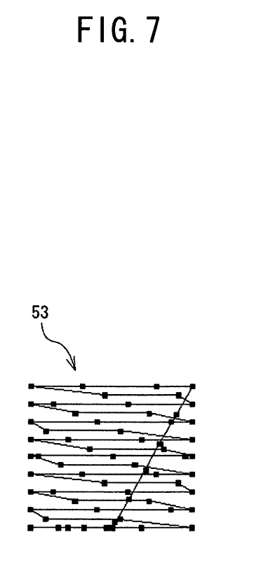

The thread density 202 is a parameter that sets an interval between each line, each line being reversed at both ends of the embroidery pattern (namely, a line is a group of stitches that continue until a reversal of direction occurs). The number of lines per millimeter (threads/mm) is set as the thread density 202 (note here that a range of the thread density 202 is from “1.0” to “7.0”). In the present embodiment, the reference value parameter of the thread density 202 is “4.5 threads/mm” (refer to FIG. 4). When “4.5 threads/mm” is set as the thread density 202 on the stitch definition table 200, the number of lines per millimeter is 4.5, as shown by the sewing mode 51 (refer to FIG. 5). When the thread density 202 is changed, for example, to “2.0 threads/mm” on the stitch definition table 200, the number of lines per millimeter is 2, as shown by a sewing mode 53 (refer to FIG. 7).

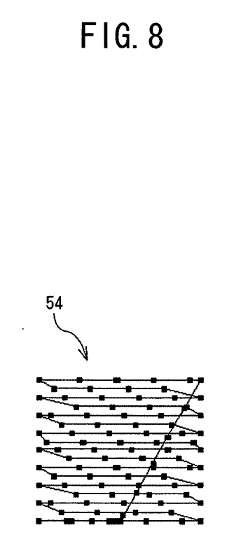

The stitch pitch 203 is a parameter that sets an interval between the needle drop points used to sew a single stitch. A length of an interval between two consecutive needle drop points (in millimeters) is set as the stitch pitch 203 (note here that a range of the stitch pitch 203 is from “1.0” to “10.0”). In the present embodiment, the reference value parameter of the stitch pitch 203 is “4.0” (refer to FIG. 4). When “4.0” is set as the stitch pitch 203 on the stitch definition table 200, the length of the interval between the needle drop points is 4 mm, as shown by the sewing mode 53 (refer to FIG. 7). When the stitch pitch 203 is changed, for example, to “2.0” on the stitch definition table 200, the length of the interval between the needle drop points is 2 mm, as shown by a sewing mode 54 (refer to FIG. 8).

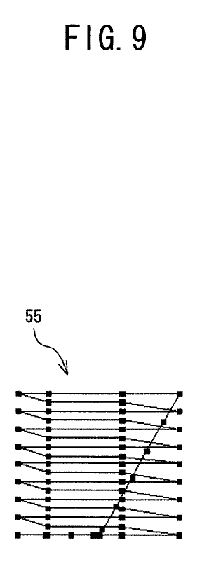

The deviation 204 is a parameter that sets to what degree needle drop points of adjacent lines will be displaced in a stitch direction. A ratio (%) is set as the deviation 204, taking the stitch length of the adjacent line as reference (note here that a range of the deviation 204 is from “0” to “99”). In the present embodiment, the reference value parameter of the deviation 204 is “30%” (refer to FIG. 4). When “30%” is set as the deviation 204 on the stitch definition table 200, of upper and lower adjacent lines shown in the sewing mode 53 (refer to FIG. 7), the needle drop points of the lower line are displaced to the right by a length that corresponds to 30% of the stitch length, in comparison to the needle drop points of the upper line. When the deviation 204 is changed, for example, to “0%” on the stitch definition table 200, the needle drop points of each of the lines are not displaced in the left-right direction and are aligned in the up-down direction, as shown by a sewing mode 55 (refer to FIG. 9).

The feather setting 205 is a parameter that is used to fade out the contour of side areas in which each line of the embroidery pattern is reversed (this technique is known as “feathering”). An execution setting 206, a side 207 and a fadeout length 208 that are sub-parameters are set in the feather setting 205. As the execution setting 206, a setting is made to determine whether or not feathering will be performed on the embroidery pattern (“ON/OFF”). As the side 207, a setting is made such that the side area in which the feathering is performed on the embroidery pattern corresponds to the stitching direction of the stitches (namely the angle 201). More specifically, when feathering is performed on a starting point side of the stitching direction (specifically, the left side area of the embroidery pattern), “starting point side” is set as the side 207. When feathering is performed on an endpoint side of the stitching direction (specifically, the right side area of the embroidery pattern), “endpoint side” is set as the side 207. When feathering is performed on both the starting point and the endpoint sides of the stitching direction (specifically, on the left and right side areas of the embroidery pattern), “both sides” is set as the side 207. As the fadeout length 208, as a length over which feathering is performed, a stitch length (mm) is set that is the length of a stitch (from the point at which the direction is reversed) positioned in the side area in which feathering is performed (note here that a range of the fadeout length 208 is from “0.1” to “100.0”).

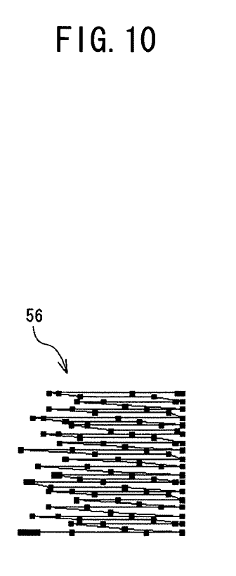

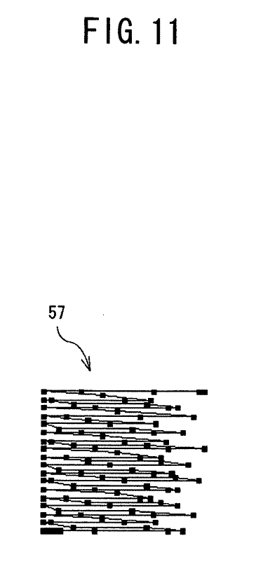

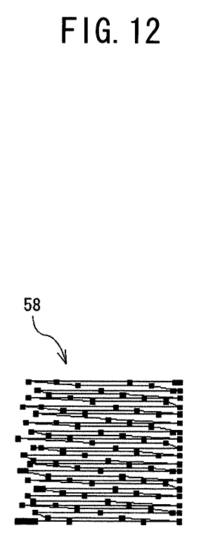

In the present embodiment, as a reference value parameter of the feather setting 205, a setting is made that indicates that feathering will not be performed (namely, the execution setting 206 is “OFF”) (refer to FIG. 4). The side 207 and the fadeout length 208 are enabled only when the execution setting 206 is “ON”. For that reason, when the execution setting 206 is “OFF”, the side 207 and the fadeout length 208 are not set. When the execution setting 206 is “OFF”, the contour of both side areas of the embroidery pattern is rectilinear, as shown by the sewing mode 51 (refer to FIG. 5). If, for example, the execution setting 206 is changed to “ON” on the stitch definition table 200, feathering is performed on the embroidery pattern in accordance with values set for the side 207 and the fadeout length 208. When, for example, the side 207 is set as the “starting point side” and the fadeout length 208 is set as “3.0 mm”, feathering is performed over a 3 mm length on the left side area of the embroidery pattern, as shown in a sewing mode 56 (refer to FIG. 10). When the side 207 is set as the “endpoint side” and the fadeout length 208 is set as “3.0 mm”, feathering is performed over a 3 mm length on the right side of the embroidery pattern, as shown by a sewing mode 57 (refer to FIG. 11). When the side 207 is set as the “starting point side” and the fadeout length 208 is set as “1.0 mm”, feathering is performed over a 1 mm length on the left side of the embroidery pattern, as shown by a sewing mode 58 (refer to FIG. 12).

Even when the execution setting 206 is “ON” on the stitch definition table 200, sometimes manual setting by the user or automatic setting (to be described later) is not performed for the side 207 and the fadeout length 208. In this case, in the present embodiment, as reference value parameters when feathering is performed, the side 207 is automatically set as the “starting point side” and the fadeout length 208 is automatically set as “1.0 mm”. In other words, when the execution setting 206 is “ON”, as long as manual setting by the user or automatic setting (to be described later) is not performed, a standard type of feathering is performed on the embroidery pattern, as shown by the sewing mode 58 (refer to FIG. 12).

As shown in FIG. 13, the parameter setting table 300 is a table that defines whether or not to automatically set the parameters that define the fill stitches (in other words, the parameters of the stitch definition table 200). As parameters, there are an angle 301, a thread density 302, a stitch pitch 303, a feather side 304 and a feather fadeout length 305. The angle 301, the thread density 302, the stitch pitch 303, the feather side 304 and the feather fadeout length 305 respectively indicate whether or not the angle 201, the thread density 202, the stitch pitch 203, the side 207 and the fadeout length 208 of the stitch definition table 200 will be automatically set. A reference displacement vector length 306 is a threshold value that is referred to when automatically setting the parameters of the stitch definition table 200, and will be explained later in more detail.

The above parameters of the parameter setting table 300 can be set manually by the user. In other words, of the parameters included in the stitch definition table 200, the user can specify, on the parameter setting table 300, the parameters that will be the target of automatic setting (to be described later).

The parameter setting table 300 in FIG. 13 shows a case in which all of the parameters of the stitch definition table 200 are not automatically set. For that reason, the angle 301, the thread density 302, the stitch pitch 303, the feather side 304 and the feather fadeout length 305 are all set to “No automatic setting”. In this case, the reference displacement vector length 306 is not set.

When all of the parameters of the parameter setting table 300 are set as “No automatic setting”, the fill stitches defined by the stitch definition table 200 are not changed for as long as the settings are not manually changed by the user. On the other hand, when there are parameters on the parameter setting table 300 that are set to “Automatic setting”, the fill stitches defined by the stitch definition table 200 are changed in accordance with those parameters. This process will be described in more detail later.

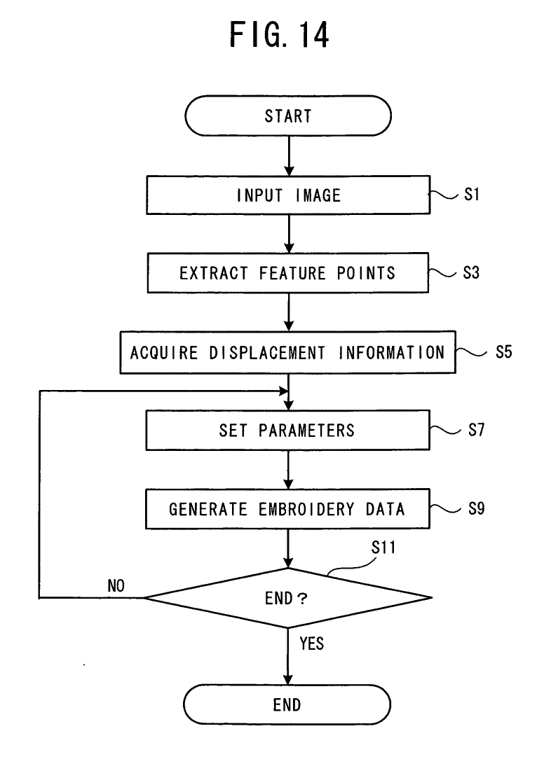

Next, a processing procedure by which the embroidery data generating apparatus 1 according to the present embodiment generates embroidery data from moving image data will be explained with reference to FIG. 14. A main process shown in FIG. 14 is performed by the CPU 11 of the embroidery data generating apparatus 1, based on the embroidery data generating program.

As shown in FIG. 14, in the main process of the present embodiment, first, image data to generate embroidery data are input (step S1). To input the image data at step S1, the user operates the mouse 22 or the keyboard 21, for example, to play back chosen moving image data that is stored in the moving image data storage area 151. A plurality of frames that form the moving image data are contiguously displayed on the display 24 in accordance with a time series T. By operating the mouse 22 or the keyboard 21 during playback of the moving image data, the user selects a frame that includes a design that will be used to create the embroidery pattern. The frame that is selected by the user is saved to the frame storage area 152 as a target frame. A frame that is played back after the target frame selected by the user (more specifically, a frame that is played back a predetermined period of time after the target frame), is saved to the frame storage area 152 as a reference frame.

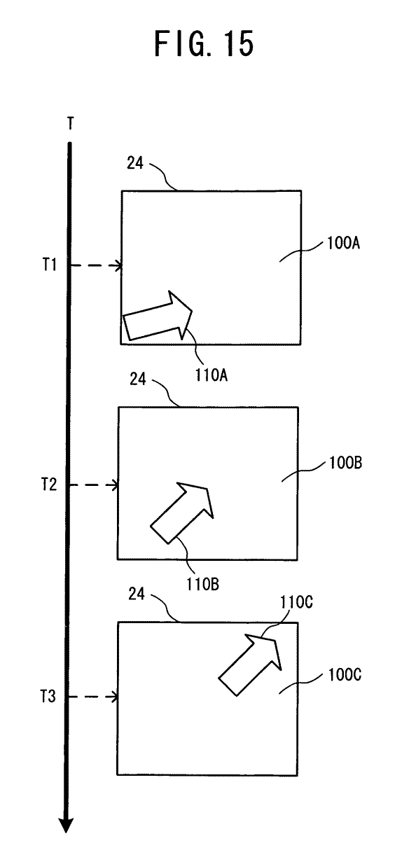

More specifically, in an example shown in FIG. 15, when moving image data that moves an arrow design cross a screen is played back, at a time T1, a frame 100A is displayed in which an arrow design 110A is positioned to the bottom left of the screen. At a time T2, which is a time point at which a predetermined period of time (one second, for example) has elapsed from the time T1, a frame 100B is displayed, on which an arrow design 110B is moving towards the center of the screen. At a time T3, which is a time point at which a predetermined period of time (one second, for example) has elapsed from the time T2, a frame 100C is displayed, on which an arrow design 110C has moved to the top right of the screen. If the user selects the frame 100B, for example, when the moving image data are being played back in this way, the frame 100B is saved as the target frame, and the frame 100C is saved as the reference frame.

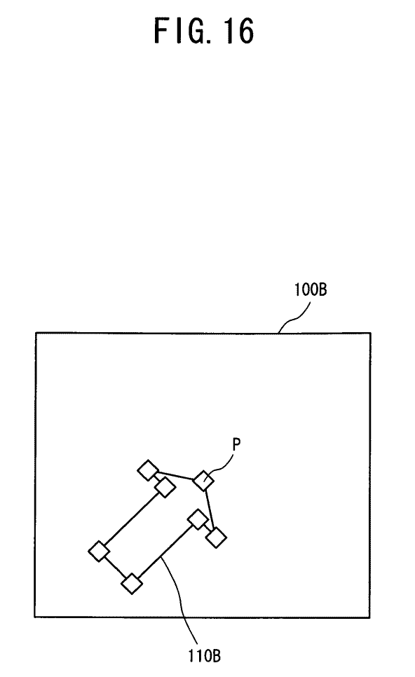

Feature points are then extracted from the image data input at step Si (step S3). At step S3, image analysis is performed on the target frame and the reference frame, respectively, and feature points are extracted that represent the shape of the design included in each of the frames. More specifically, by performing image analysis on the frame 100B that is the target frame, feature points P (shown as hollow points) that represent the shape of the arrow design 110B are extracted, as shown in FIG. 16. Similarly, although not shown in the drawings, image analysis is also performed on the frame 100C that is the reference frame, and feature points P′ are extracted that represent the shape of the arrow design 110C. A variety of known techniques can be adopted to extract feature points from image data, and a detailed explanation of the procedures is omitted here.

Based on the feature points extracted at step S3, displacement information for the image data input at step S1 can be acquired (step S5). At step S5, a barycentric position of the feature points extracted at step S3 is calculated for the target frame and the reference frame, respectively. The barycentric position of the feature points is calculated, for example, as a coordinate position when a mean value coordinate position is taken for each of the feature points. A direction and a distance from the barycentric position of the target frame to the barycentric position of the reference frame (namely, a displacement vector) are calculated as displacement information of the image data.

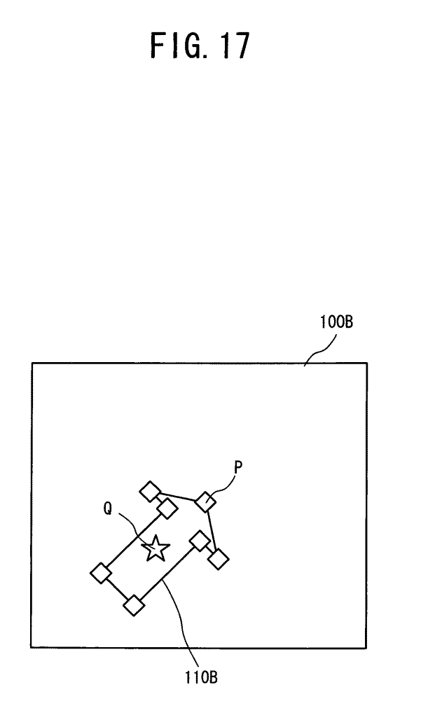

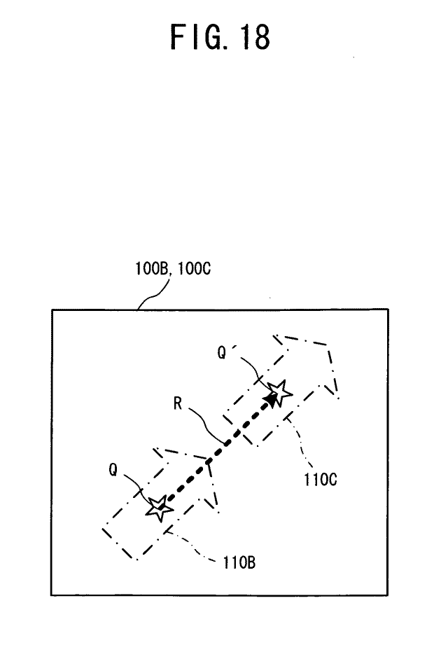

More specifically, the mean value coordinate position of the feature points P of the arrow design 110B (refer to FIG. 16) is calculated, and a barycentric position Q (shown as a star) of the arrow design 110B is acquired, as shown in FIG. 17. Similarly, although not shown in the drawings, the mean value coordinate position of the feature points P′ of the arrow design 110C is calculated, and a barycentric position Q′ is acquired. A direction and a distance from the barycentric position Q to the barycentric position Q′ (a displacement vector R) is acquired, as shown in FIG. 18. The displacement vector R has the barycentric position Q as its starting point, and the barycentric position Q′ as its endpoint. In other words, the displacement vector R indicates the direction and length of displacement by which the arrow design 110B is displaced to the arrow design 110C, in accordance with the playback order of the frame 100B and the frame 100C in the moving image data.

Based on the displacement vector acquired at step S5, the parameters that define the fill stitches are set (step S7). At step S7, the parameters of the stitch definition table 200 corresponding to the parameters that are set as “Automatic setting” on the parameter setting table 300 are automatically set based on the displacement vector acquired at step S5. This process will be explained in more detail later.

Based on the image data input at step S1, embroidery data are generated to be used in performing embroidery by the sewing machine 3 (step S9). At step S9, in a similar way to generation of embroidery data from image data in known art, the design included in the target frame (in the present embodiment, the arrow design 110B included in the frame 100B) is converted to embroidery data. More specifically, the embroidery data is generated that causes the sewing machine 3 to sew the embroidery pattern of the design that is included in the target frame, with the fill stitches defined by the stitch definition table 200. The embroidery data generated at step S9 are saved to the embroidery data storage area 155.

The embroidery data that are generated at step S9 are, for example, displayed on the display 24. The user confirms the embroidery data displayed on the display 24 and specifies whether to end or to redo the embroidery data generation process. When the user specifies to end the embroidery data generation process (yes at step S11), the main process is ended. When the user specifies to redo the embroidery data generation process (no at step S11), the process returns to step S7. Before specifying to redo the embroidery data generation process, by changing the settings on the stitch definition table 200 and the parameter setting table 300, the user can acquire embroidery data of a different sewing mode to that previously acquired (step S7 and step S9).

After ending the main process (refer to FIG. 14), the user writes the embroidery data stored in the embroidery data storage area 155 to the memory card 155, for example. The user inserts the memory card 115 on which the embroidery data are written into the memory card slot 37 of the sewing machine 3. Based on the embroidery data read out from the memory card 115, the sewing machine 3 sews the embroidery pattern of the design (in the present embodiment, the arrow design 110B) on the work cloth using the fill stitches defined by the stitch definition table 200. In this way, the design included in the frame that is freely specified from the moving image data is represented as the embroidery pattern on the work cloth.

The relationship between the parameters set at step S7 and the embroidery data generated at step S9 will be explained with reference to FIG. 4, FIG. 13 and FIG. 19 to FIG. 22. Hereinafter, an explanation will be made in which the above-described reference value parameters are set on the stitch definition table 200 in advance (refer to FIG. 4).

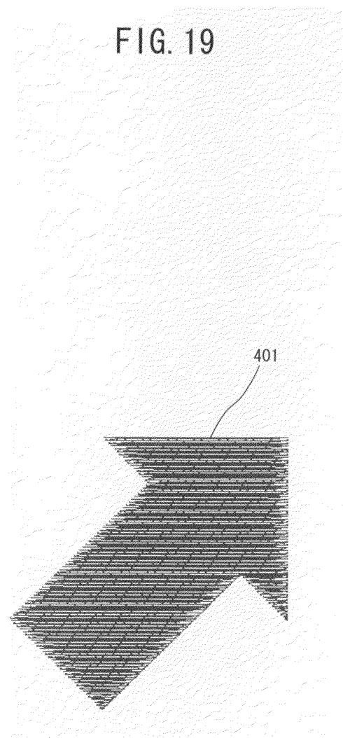

In the example of the parameter setting table 300 shown in FIG. 13, the parameters set in the stitch definition table 200 at step S7 are not changed, regardless of the displacement vector acquired at step S5. At step S9, the embroidery data are generated based on the reference value parameters of the stitch definition table 200 (refer to FIG. 4). In the sewing machine 3, based on the embroidery data generated based on the reference value parameters, an embroidery pattern 401 (refer to FIG. 19), for example, is sewn onto the work cloth. In the example of the embroidery pattern 401 shown in FIG. 19, the arrow design 110B is sewn using the fill stitches. The sewing mode of the embroidery pattern 401 has the same angle and thread density as that of the sewing mode 51 (refer to FIG. 5), and has the same stitch pitch and deviation as that of the sewing mode 53 (refer to FIG. 7). In the sewing mode of the embroidery pattern 401, similarly to the sewing mode 51 (refer to FIG. 5) etc., feathering is not performed.

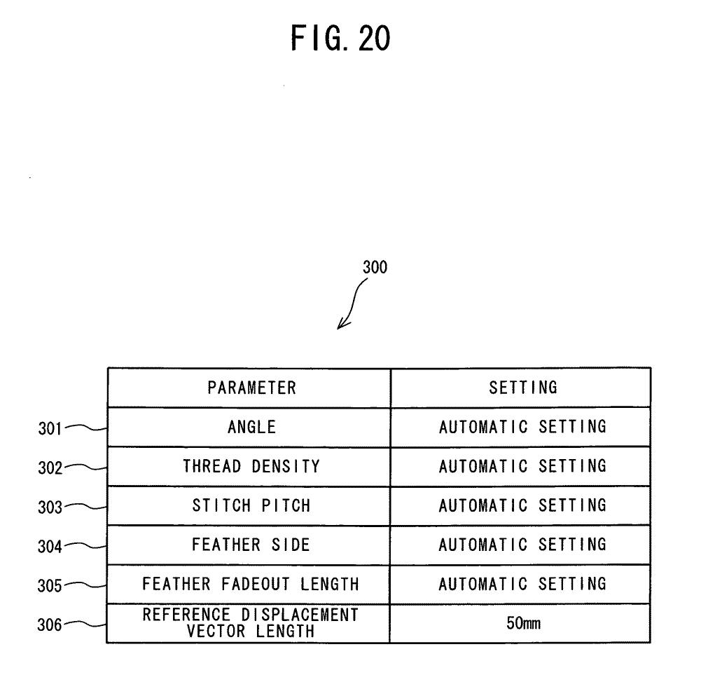

In an example of the parameter setting table 300 shown in FIG. 20, each of the parameters (the angle 301, the thread density 302, the stitch pitch 303, the feather side 304 and the feather fadeout length 305) is set to “Automatic setting”. “50 mm” is set as the reference displacement vector length 306. When there are parameters for which “Automatic setting” is set in the parameter setting table 300 in this way, the parameters of the stitch definition table 200 are automatically set at step S7 in the way described below.

When “Automatic setting” is set for the angle 301, the orientation of the displacement vector acquired at step S5 is set as the angle 201 in the stitch definition table 200. For example, when the orientation of the above-described displacement vector R (refer to FIG. 18) is “45 degrees”, “45 degrees” is set as the angle 201 in the stitch definition table 200. At step S9, embroidery data are generated for a sewing mode that has a stitching direction of 45 degrees (refer to the sewing mode 52 in FIG. 6). In the embroidery pattern that is sewn based on this embroidery data, the stitching direction visually represents the displacement direction of the arrow design 110B. In this way, a person viewing the embroidery pattern can be afforded an impression that the arrow design 110B of the embroidery pattern, for example, is moving in the displacement direction.

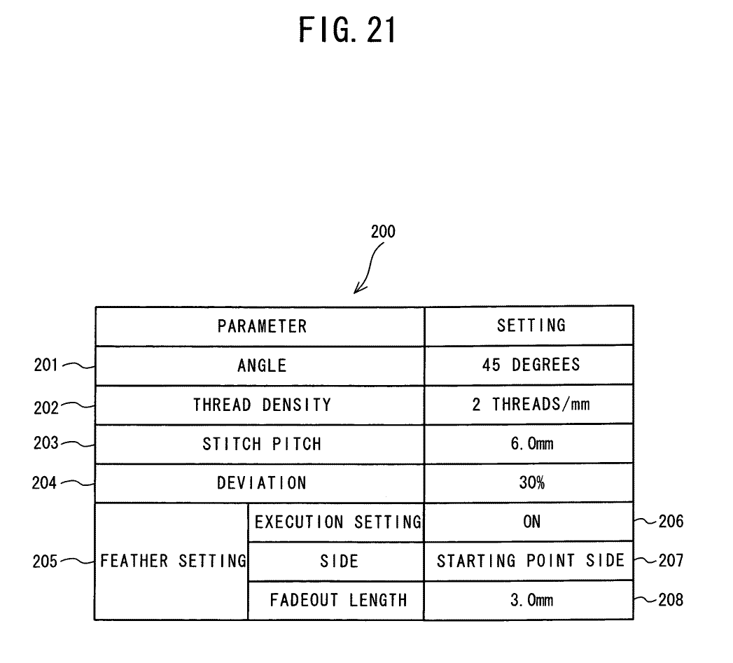

When “Automatic setting” is set for the thread density 302, the thread density 202 in the stitch definition table 200 is set to a value that corresponds to the length of the displacement vector acquired at step S5. More specifically, when the displacement vector R is longer than the reference displacement vector length 306, a value that is smaller than the reference value parameter (“4.5 threads/mm” in the present embodiment) is set as the thread density 202. When the displacement vector R is shorter than the reference displacement vector length 306, a value that is greater than the reference value parameter is set as the thread density 202. The value that is set as the thread density 202 is a value obtained by dividing the reference value parameter by a ratio of the length of the displacement vector R to the reference displacement vector length 306. For example, when the length of the displacement vector R is “112.5 mm”, as it is longer than the reference displacement vector length 306 of “50 mm” (refer to FIG. 20), the thread density 202 on the stitch definition table 200 is set as “2.0 threads/mm”) (refer to FIG. 21). At step S9, embroidery data are generated for a sewing mode in which there are two lines sewn per millimeter (refer to the sewing mode 53 in FIG. 7). In the embroidery pattern that is sewn based on this embroidery data, the length of the displacement of the arrow design 110B is visually represented by the thread density. In this way, it is possible to convey to a person viewing the embroidery pattern the impression that the embroidery pattern with a small thread density, for example, is moving at high speed, while, by increasing the thread density, it is possible to convey the impression that the embroidery pattern is moving at a slow speed.

When the stitch pitch 303 is set as “Automatic setting”, the stitch pitch 203 on the stitch definition table 200 is set to a value that corresponds to the length of the displacement vector acquired at step S5. More specifically, when the displacement vector R is longer than the reference displacement vector length 306, a value that is larger than the reference value parameter (“4.0 mm” in the present embodiment) is set as the stitch pitch 203. When the displacement vector R is shorter than the reference displacement vector length 306, a value that is smaller than the reference value parameter is set as the stitch pitch 203. The value that is set as the stitch pitch 203 is a value obtained by multiplying the reference value parameter by a ratio of the length of the displacement vector R to the reference displacement vector length 306. For example, when the length of the displacement vector R is “75 mm”, as this is longer than the reference displacement vector length 306 of “50 mm” (refer to FIG. 20), the stitch pitch 203 on the stitch definition table 200 is set as “6 mm” (refer to FIG. 21). At step S9, embroidery data are generated for a sewing mode in which an interval between needle drop points is 6 mm. In the embroidery pattern that is sewn based on this embroidery data, the length of the displacement of the arrow design 110B is visually represented by the stitch pitch. In this way, by increasing the stitch pitch, for example, it is possible to convey to a person viewing the embroidery pattern the impression that the embroidery pattern is moving at high speed, while, by decreasing the stitch pitch, it is possible to convey the impression that the embroidery pattern is moving at a slow speed.

When the feather side 304 is set to “Automatic setting”, the starting point side of the displacement vector acquired at step S5 is set as the side 207 in the stitch definition table 200 (refer to FIG. 21). For example, the starting point side of the displacement vector R shown in FIG. 18 corresponds to the left side of the embroidery pattern, and therefore, embroidery data are generated at step S9 for a sewing mode in which feathering is performed on the left side of the embroidery pattern (refer to the sewing mode 56 in FIG. 10). In the embroidery pattern sewn based on this embroidery data, the displacement direction of the arrow design 110B is visually represented by the feathered side. In this way, by performing feathering on the starting point side of the displacement vector, for example, a person viewing the embroidery pattern can be given the impression that the embroidery pattern is moving in the displacement direction of the arrow design 110B.

When the feather fadeout length 305 is set to “Automatic setting”, the fadeout length 208 in the stitch definition table 200 is set to a value that corresponds to the length of the displacement vector acquired at step S5. More specifically, when the displacement vector R is longer than the reference displacement vector length 306, a value that is larger than the reference value parameter at the time of performing feathering (“1.0 mm” in the present embodiment) is set as the fadeout length 208. When the displacement vector R is shorter than the reference displacement vector length 306, a value that is smaller than the reference value parameter is set as the fadeout length 208. The value that is set as the fadeout length 208 is a value obtained by multiplying the reference value parameter by a ratio of the length of the displacement vector R to the reference displacement vector length 306. For example, when the length of the displacement vector R is “150 mm”, as this is longer than the reference displacement vector length 306 of “50 mm” (refer to FIG. 20), the fadeout length 208 on the stitch definition table 200 is set as “3 mm” (refer to FIG. 21). At step S9, embroidery data are generated for a sewing mode in which feathering is performed over a length of 3 mm (refer to the sewing mode 56 in FIG. 10). In the embroidery pattern that is sewn based on this embroidery data, the length of the displacement of the arrow design 110B is visually represented by the feather fadeout length. In this way, by increasing the feather fadeout length, for example, it is possible to give a person viewing the embroidery pattern the impression that the embroidery pattern is moving at high speed, while, by decreasing the feather fadeout length, it is possible to convey the impression that the embroidery pattern is moving at a slow speed.

When the feather side 304 is set to “Automatic setting”, even if the execution setting 206 on the stitch definition table 200 is “OFF”, feathering is performed on the embroidery pattern. In other words, even when the execution setting 206 is set to “OFF”, if the feather side 304 is set to “Automatic setting”, the execution setting 206 is set to “ON” at step S7, and the side 207 is set based on the above-described displacement vector.

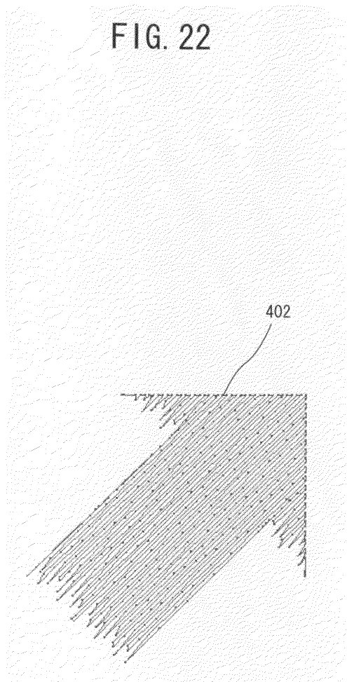

When the parameter setting table 300 shown in FIG. 20 is defined in this way, the parameters of the stitch definition table 200 shown in FIG. 21 are automatically set at step S7 in accordance with the displacement vector. At step S9, embroidery data are generated based on the parameters after the automatic settings are made. In the sewing machine 3, based on this embroidery data, an embroidery pattern 402 (refer to FIG. 22), for example, is sewn onto the work cloth. In the example of the embroidery pattern 402 shown in FIG. 22, similarly to the embroidery pattern 401 (refer to FIG. 19), the arrow design 110B is sewn using fill stitches. However, the embroidery pattern 402 uses a dynamic sewing mode that reflects the displacement of the arrow design 110B based on the displacement vector R, and is thus different in this respect from the embroidery pattern 401 (refer to FIG. 19), which uses a static sewing mode.

As described above, in the embroidery data generating apparatus 1 according to the present embodiment, a freely specified target frame (the frame 100B) and a reference frame (the frame 100C) that follows the target frame are acquired from among a plurality of contiguous frames that form moving image data. Based on the feature points P of the arrow design 110B that is included in the frame 100B and the feature points P′ of the arrow design 110C that is included in the frame 100C, the displacement vector R obtained when the arrow design 110B is displaced is acquired. While referring to the parameters of the stitch definition table 200 that are set based on the displacement vector R, the embroidery data generating apparatus 1 generates the embroidery data to enable the sewing machine 3 to sew the arrow design 110B in embroidered form. In this way, the embroidery data generating apparatus 1 can generate embroidery data that causes the sewing machine 3 to sew a dynamic embroidery pattern that brings to life the features of a moving image. Additionally, the sewing machine 3 that performs the sewing operation based on this embroidery data can represent the displacement of the arrow design 110B using the embroidery pattern, in accordance with the parameters set on the stitch definition table 200 (namely, the angle of the stitches, the stitch pitch, the thread density and feathering when the sewing machine 3 performs embroidering).

Note that the embroidery data generating apparatus 1 according to the present disclosure is not limited to the above-described exemplary embodiment, and various modifications can of course be made. In the above-described exemplary embodiment, examples are described in which a plurality of parameters (stitch direction, stitch length, stitch density, feather settings) are referred to when the embroidery data are generated, but the embroidery data may be generated as long as at least one parameter is referred to.

In the above-described exemplary embodiment, when setting the parameters at step S7, the stitch definition table 200 is set based on the parameter setting table 300 and the displacement vector R, but a new set value table that is different to the stitch definition table 200 may be used to perform parameter settings. At step S9, the embroidery data may be generated based on the new set value table. In this case, all of the set values in the stitch definition table 200 are not changed, and thus the stitch definition table 200 is maintained in the default state. When the embroidery data are next generated (no at step S11), the embroidery data maybe generated at step S9 based on the stitch definition table 200 that is in the default state. In this way, the user can be saved the time and effort of resetting the stitch definition table 200 to the default state.

In the above-described exemplary embodiment, by image input performed at step S1, a frame that is played back within a predetermined period of time (1 second, for example) after a target frame when moving image data are played back is acquired as a reference frame. However, the reference frame is not limited to this example. The reference frame may be a frame that is played back a predetermined number of frames (5 frames, for example) after the target frame, when the moving image data are played back.

In the above-described exemplary embodiment, by the image input performed at step S1, a frame that follows the target frame is acquired as the reference frame, but the reference frame is not limited to this example. The reference frame may be a frame that is played back a predetermined period of time (1 second, for example) or a predetermined number of frames (5 frames, for example) before the target frame, when the moving image data are played back.

For example, in the example shown in FIG. 15, when the frame 100B that is selected by the user is acquired as the target frame, the frame 100A may be acquired as the reference frame at the same time. In this case also, the main process (refer to FIG. 4) is similar to that described above, but a method to acquire the displacement vector R is different. As the frame 100A precedes the frame 100B in the playback order of the moving image data, at step S5, the displacement vector R is acquired, which has the barycentric position Q″ of the arrow design 110A as its starting point and the barycentric position Q of the arrow design 110B as its endpoint.

In addition, by the image input performed at step S1, a frame preceding the target frame and a frame following the target frame may both be acquired as the reference frames. For example, in the example shown in FIG. 15, the frame 100B that is selected by the user is acquired as the target frame, and at the same time, the frames 100A and 100C are both acquired as the reference frames. In this case, at step S7, parameters settings are performed based on a displacement vector R1 between the frame 100A and the frame 100B and a displacement vector R2 between the frame 100B and the frame 100C (for example, a sum or an average value of the displacement vectors R1 and R2).

In the above-described embodiment, the image input is performed at step S1, and the target frame and the reference frame are acquired from the moving image data. However, the method of acquiring the target frame and the reference frame is not limited to this example. For example, two image data selected and input by the user may be acquired as the target frame and the reference frame. The two image data can be selected image data that are, for example, acquired via a network that is not shown in the drawings, or image data that are read from the scanner 25 etc. It is, however, preferable that the images of the two image data have a common design that will be sewn as the embroidery pattern, and that movement of the design has continuity. It is preferable that the user is caused to input information indicating to which of the target frame and the reference frame the two image data respectively correspond (for example, the user is caused to select, from the two image data, a target image from which the embroidery data is to be generated). By this, even when the frame is not acquired from moving image data, the embroidery data generating apparatus 1 can generate embroidery data that causes the sewing machine 3 to sew a dynamic embroidery pattern from a plurality of image data.

In the above-described exemplary embodiment, the embroidery data generating apparatus 1 is a personal computer, but the embroidery data generating apparatus 1 is not limited to this example. By storing the embroidery data generating program in the sewing machine 3, the sewing machine 3 may function as the embroidery data generating apparatus 1 and generate the embroidery data.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. An embroidery data generating apparatus comprising:
a data acquisition device that acquires, from among a plurality of image data, a single image data as a target data, and at least one image data as a reference data, the reference data being different from the target data;
a feature point extraction device that extracts, respectively, a first feature point representing a shape of a first target image contained in the target data, and a second feature point representing a shape of a second target image contained in the reference data;
a displacement vector identification device that, based on the first feature point and the second feature point extracted by the feature point extraction device, identifies a displacement vector that is obtained when one of the first target image and the second target image is displaced to a position of the other target image;
a parameter setting device that, based on the displacement vector identified by the displacement vector identification device, sets embroidery parameters that are referred to when generating embroidery data used to perform embroidery by a sewing machine; and
an embroidery data generating device that refers to the embroidery parameters set by the parameter setting device and generates the embroidery data that causes the sewing machine to embroider the first target image.

2. The embroidery data generating apparatus according to claim 1, wherein:
the embroidery parameters include at least one of a stitch direction, a stitch pitch, a stitch density and a feather setting that is used to fade out a contour of an embroidery pattern.

3. The embroidery data generating apparatus according to claim 2, wherein:
the parameter setting device sets the stitch direction included in the embroidery parameters as a direction of the displacement vector.

4. The embroidery data generating apparatus according to claim 2, wherein:
the parameter setting device sets the stitch pitch included in the embroidery parameters as a longer setting when a length of the displacement vector is larger than a reference value and as a shorter setting when the length of the displacement vector is smaller than the reference value.

5. The embroidery data generating apparatus according to claim 2, wherein:
the parameter setting device sets the stitch density included in the embroidery parameters as a lower setting when a length of the displacement vector is larger than a reference value and as a higher setting when the length of the displacement vector is smaller than the reference value.

6. The embroidery data generating apparatus according to claim 2, wherein:
the parameter setting device sets, in the feather setting included in the embroidery parameters, as a position of a contour on which the feathering is performed on the embroidery pattern, a starting point side of the displacement vector.

7. The embroidery data generating apparatus according to claim 6, wherein:
the parameter setting device sets, in the feather setting included in the embroidery parameters, as a length over which the feathering is performed on the embroidery pattern, a longer setting when a length of the displacement vector is larger than a reference value and a shorter setting when the length of the displacement vector is smaller than the reference value.

8. A computer-readable medium storing an embroidery data generating program, the program comprising instructions that cause a computer to perform the steps of:
acquiring, from among a plurality of image data, a single image data as a target data, and at least one image data as a reference data, the reference data being different from the target data;
extracting, respectively, a first feature point representing a shape of a first target image contained in the target data, and a second feature point representing a shape of a second target image contained in the reference data;
identifying, based on the first feature point and the second feature point, a displacement vector that is obtained when one of the first target image and the second target image is displaced to a position of the other target image;
setting, based on the displacement vector, embroidery parameters that are referred to when generating embroidery data used to perform embroidery by a sewing machine; and
referring to the embroidery parameters and generating the embroidery data that causes the sewing machine to embroider the first target image.

9. The computer-readable medium according to claim 8, wherein:
the embroidery parameters include at least one of a stitch direction, a stitch pitch, a stitch density and a feather setting that is used to fade out a contour of an embroidery pattern.

10. The computer-readable medium according to claim 9, wherein:
in the step of setting the embroidery parameters, the stitch direction that is included in the embroidery parameters is set as a direction of the displacement vector.

11. The computer-readable medium according to claim 9, wherein:
in the step of setting the embroidery parameters, the stitch pitch included in the embroidery parameters is set as a longer setting when a length of the displacement vector is larger than a reference value and as a shorter setting when the length of the displacement vector is smaller than the reference value.

12. The computer-readable medium according to claim 9, wherein:
in the step of setting the embroidery parameters, the stitch density included in the embroidery parameters is set as a lower setting when a length of the displacement vector is larger than a reference value and as a higher setting when the length of the displacement vector is smaller than the reference value.

13. The computer-readable medium according to claim 9, wherein:
in the step of setting the embroidery parameters, in the feather setting included in the embroidery parameters, a starting point side of the displacement vector is set as a position of a contour on which the feathering is performed on the embroidery pattern.

14. The computer-readable medium according to claim 13, wherein:
in the step of setting the embroidery parameters, in the feather setting included in the embroidery parameters, as a length over which the feathering is performed on the embroidery pattern, a longer setting is set when a length of the displacement vector is larger than a reference value and a shorter setting when the length of the displacement vector is smaller than the reference value.

15. An embroidery data generating apparatus comprising:
a frame acquisition device that respectively acquires from moving image data, of a plurality of contiguous frames included in the moving image data, a freely specified target frame, and a reference frame that includes at least one of a frame that is played back before the target frame and a frame that is played back after the target frame in a playback order of the moving image data;
a feature point extraction device that extracts, respectively, a first feature point representing a shape of a first target image contained in the target frame, and a second feature point representing a shape of a second target image contained in the reference frame;
a displacement vector identification device that, in accordance with the playback order of the target frame and the reference frame in the moving image data and based on the first feature point and the second feature point extracted by the feature point extraction device, identifies a displacement vector that is obtained when one of the first target image and the second target image is displaced to a position of the other target image;
a parameter setting device that, based on the displacement vector identified by the displacement vector identification device, sets embroidery parameters that are referred to when generating embroidery data used to perform embroidery by a sewing machine; and
an embroidery data generating device that refers to the embroidery parameters set by the parameter setting device and generates the embroidery data that causes the sewing machine to embroider the first target image.
